(19) United States
(12) Patent Application Publication
(10) Pub. No.: US 2023/0274624 A1
(43) Pub. Date: Aug. 31, 2023

(54) NOTIFICATION SYSTEM FOR BUILDINGS

(71) Applicant: Masamichi KAMEI, Tokyo (JP)

(72) Inventor: Masamichi KAMEI, Tokyo (JP)

(21) Appl. No.: 18/005,865

(22) PCT Filed: Apr. 5, 2021
(86) PCT No.: PCT/JP2021/014497

§ 371 Date: Jan. 18, 2023

(30) Foreign Application Priority Data
Jul. 21, 2020 (JP) 2020-124249
Nov. 17, 2020 (JP) 2020-190832

(51) Int. Cl. G08B 7/06; G08B 21/02

(52) U.S. Cl. CPC G08B 7/064; G08B 21/02

(57) ABSTRACT

The purpose of the present application is to provide a notification system that is for buildings, that can be introduced and widely used in ordinary collective housing and office complexes without the need to make a large investment in equipment, and that enables an emergency event taking place in a building to be detected by passersby passing the vicinity of the building. An emergency event display device equipped with a large screen display is installed in a position that is visible to passersby passing outside the building. When there is some emergency event in the building, an indication of the emergency event is displayed on the display device upon receipt of notification from a residence or a common use space where a notification means is installed. A display of the display device normally shows an ornamental picture or video so as to soothe the residents walking in and out of the building or the passersby passing in front of the building, whereby an impression of the building can be bolstered. The display device is made noticeable not only to residents but also to passersby passing in front of the building so as to make it possible to report an emergency event in an efficient way and consequently provide safety for the residents.

### TECHNICAL FIELD

This invention relates to a notification system that is for buildings and that is mainly applied to collective housing and office complexes. This notification system is configured so as to enable an emergency event to be notified not only to residents in a building but also to passersby through the medium of a display means installed in a position that is visible to passersby passing outside a building such as a position that is visible from a road or a passage nearby the building, particularly in cases where there is some resident's sudden illness, injury or like physical disorder in the building or where there is some intrusion by an illegal intruder into a residence.

### BACKGROUND ARTS

As for countermeasures to an emergency event in cases where there is a fire in a building, some type of notification system with which a fire alarm in a building is operated and/or an occurrence of a fire is notified to a building management office or to a remote monitoring facility is commonly known.

Meanwhile, other various types of notification systems have been developed, such as a system with which not only an occurrence of a fire but also resident's sudden illness is notified and a system with which intrusion by a suspicious person into a building is notified in linkage with a monitoring camera.

For instance, in relation to one notification system that is for collective housing such as condominium buildings and apartments and that is configured so as to enable an abnormality event to be notified to residents each other through a domestic electric light line of each individual residence, a patent document 1 below discloses an inter-neighboring residence's mutual abnormality monitoring and notifying system configured so as to allow the residents of the neighboring residences to recognize each other which residence an abnormality event such as fires, temperature rises and gas leakages occurs in.

As one crime prevention system that shows the effectiveness of crime prevention even when a building manager overlooks an intruder or is on patrol or otherwise, is absent at night, a patent document 2 below discloses a crime prevention system configured such that a plurality of crime prevention cameras installed in a common use space such as corridors and elevator halls in a condominium building, a shared monitor installed in the common use space, an intimidation unit installed nearby a spot that is to be imaged by each crime prevention camera and a monitoring device installed every residence in the building are all connected to a management device that is for management of image data imaged by each crime prevention camera.

As one emergency notification system that allows a system user to freely set and change a notification destination in accordance with the contents of an emergency event, a patent document 3 below discloses a system that interconnects and groups independent basic notification systems installed every residence or every common use space, and monitors and controls individual basic notification systems with both of a central monitoring device installed inside a building and a base station located outside the building.

The emergency notification system as disclosed in the patent document 3 is configured such that each basic notification system is constituted of monitoring sensors installed in respective rooms and a controller for monitoring and controlling the monitoring sensors, wherein each monitoring sensor is connected to the controller via a wire, while interconnection between the controllers of the respective basic notification systems and interconnection between the controllers and the central monitoring device are respectively made via a wire, the central monitoring device being connected to the base station, and wherein wireless communication between the controller and a mobile phone is made establishable.

As one collective housing intercom system, a patent document 4 below describes that a room master unit is equipped with an emergency button etc., and upon depression of the emergency button, an abnormality occurrence signal is sent to a collective entrance unit through a control device, and consequently, the collective entrance unit having received the abnormality occurrence signal displays room information and classification information of an abnormality occurrence signal sender, that the collective entrance unit has an alarm sound emitting speaker, and that an alarm signal is outputted to a security company to allow information similar to that displayed on the collective entrance unit to be displayed.

In relation to one intercom system, a patent document 5 below describes that information such as promotional information of each company and regional information from a local government is displayed on a display part of a collective entrance unit, and that displayed data may be in the form of data made uploadable by an information provider (such as companies and local governments).

A patent document 6 below discloses a transparent collective display body that has a multi-layered bright drawing part therein to normally display information requested by a user side in a drawing manner, while in an occurrence of an emergency event, systematically guaranteeing safety on the user side by taking required measures speedily and securely through the processing of transmitting the fact of the emergency event occurring to a remote countermeasure organization and the like using an information technology on the basis of drawing. This patent document 6 also discloses a safety guarantee system and a safety guarantee device with which an indication displayed on the transparent collective display body is transmitted to an emergency countermeasure organization via an external information terminal. Examples of objects for application include vehicles such as buses, taxies, private cars, cash transport vehicles and emergency response vehicles, ships and/or airplanes, convenience stores, post offices, financial institutions, automated fare adjustment boxes, securities companies, insurance companies, vending machines, laundromats, residences, stores, department stores, dormitories, condominium buildings, various stops or stations, collective buildings and office complexes.

A patent document 7 below discloses a lobby intercom that is for collective housing, that is installed in a common entrance of the collective housing and that incorporates a controller that is for calling a residence information board installed every residence to perform control of speech communication through the medium of an intercom, while detecting and discriminating a signal issued from a security sensor etc. additionally connected to the residence information board to output an alarm signal, wherein the controller is configured so as to output the alarm signal when an abnormality signal is returned from the residence information board that is polled at the time that polling scan of the residence information board is executed, while causing an address allocated to the residence information board having returned the abnormality signal to be displayed on a display part.

A patent document 8 below discloses a fire alarm system comprising a plurality of fire sensors arranged at different rooms in a facility to detect an occurrence of a fire, a fire occurrence spot identifying part for identifying a fire occurrence spot on the basis of the result of detection by the fire sensors, a detection part for detecting as to whether or not there are still people in the facility, and a display device for displaying information indicative of the fire occurrence spot when the occurrence of a fire is detected by at least one of the fire sensors and also when no presence of any people is detected by the detection part.

### PRIOR ART DOCUMENTS

### Patent Documents

Patent document 1: Japanese Unexamined Patent Application Publication No. 2002-245576
Patent document 2: Japanese Unexamined Patent Application Publication No. 2003-085662
Patent document 3: Japanese Unexamined Patent Application Publication No. 2006-323490
Patent document 4: Japanese Unexamined Patent Application Publication No. 2012-034115
Patent document 5: Japanese Unexamined Patent Application Publication No. 2019-047199
Patent document 6: Japanese Unexamined Patent Application Publication No. 2003-167539
Patent document 7: Japanese Unexamined Patent Application Publication No. Hei05-174276
Patent document 8: Japanese Unexamined Patent Application Publication No. 2018-142227

### SUMMARY OF THE INVENTION

### Problems to be Solved by the Invention

The mutual abnormality monitoring and notifying system as disclosed in the patent document 1 is configured so as to enable the abnormality event to be mutually monitored between the neighboring residences in the building, in which case, however, the effectiveness of such mutual monitoring becomes an issue because of the presence of many residents who feel unpleasant by mutual monitoring in a compulsory manner, and besides, a high cost is indispensable.

The crime prevention system as disclosed in the patent document 2 is to obtain a high crime-preventive function mainly with the large number of crime prevention cameras, the intimidation unit installed nearby the spot to be imaged and the monitoring device installed every residence, in which case, however, there is a problem that this crime prevention system requires much expense.

The emergency notification system as disclosed in the patent document 3 is to provide a thorough monitoring system configuration, in which case, however, there is the need to make a large investment in equipment, and consequently, introduction of this emergency notification system into the ordinary collective housing and/or into the office complexes is considered to be difficult.

The collective entrance unit in the collective housing intercom system as disclosed in the patent document 4 is such a collective entrance unit as being installed in the entrance to allow a visitor to call and have speech communication with the resident, and accordingly, a room information and/or classification information indication is supposed to appear merely on the collective entrance unit even in the presence of such indication displayed in response to the abnormality occurrence signal in emergencies, thereby resulting in no possibility that the displayed information on the collective entrance unit will be confirmed from the outside of the building. In other words, it is not possible for the passersby passing nearby the building to perceive the emergency event.

The promotional information of each company, the regional information from the local government or like information displayed on the display part of the collective entrance unit in the intercom system as disclosed in the patent document 5 is mainly for the building residents, and is not considered to be aimed at notifying an emergency event in the building to the passersby passing nearby the building.

While the safety guarantee system as disclosed in the patent document 6 is a system that is characterized by a mechanism and/or a function of the transparent collective display body as one display body, the invention as disclosed in the patent document 7 is an invention that relates to the intercom system, likewise the inventions as disclosed in the patent documents 4 and 5, and the invention as disclosed in the patent document 8 is an invention that relates to the fire alarm system, it is to be understood that these inventions should be not considered to be for notifying the emergency event in the building to the passerby passing nearby the building.

In view of the about circumstances, an object of the present invention is to provide a notification system that is for buildings, that can be introduced and widely used in ordinary collective housing and office complexes without the need to make a large investment in equipment, and that enables an emergency event taking place in a building to be detected also by the passersby passing nearby the building, thereby resulting in providing safety for the building residents.

### Means for Solving the Problems

A notification system for buildings according to the present invention is characterized in that an emergency event notification means is installed in each individual residence or a common use space in a building, the emergency event notification means being connected to an in-building network based on a communication means to send an emergency event notification; and an emergency event display means is installed on an exterior wall surface of the building so as to be located in a position that is visible to passersby passing outside the building, the emergency event display means being for receiving the emergency event notification sent by the emergency event notification means, followed by displaying information concerning an emergency event notified by the emergency event notification means, together with information concerning a residence or common use space location where the emergency event notification is sent.

More specifically, the position that is visible to the passersby passing outside the building is considered to be a position that is visible from a road or a passage nearby that building, for instance, and hence, installation of the emergency event display means on the exterior wall surface of the building, namely, a noticeable place such as an exterior wall surface close to a building entrance, for instance, enables the emergency event to be easily detected not only by the residents in the building but also by the passersby passing nearby the building.

Even when a building manager is absent, early countermeasures against the emergency event can be taken thanks to early emergency event detection by the residents or by the passersby.

The emergency event display means may be installed also outside the building within a building site, for instance, without being limited to the exterior wall surface of the building. For instance, installation of the emergency event display means within the building site so as to be located in front of the building or in a position close to a road around the building allows the passersby passing outside the building to easily recognize the emergency event display means. Further, installation of the emergency event display means within the building site so as to be located in a position that is visible from roads around the building site can lead to a reduction in land rent for installation thereof and to facilitation of management and/or maintenance thereof as well.

Meanwhile, installation of the emergency event display means in a plurality of places without being limited to one place is considered to be more effective, and hence, a separate emergency event display means may be installed also in an entrance of the building and/or in a position close to other side entrance of the building, in addition to the emergency event display means installed in the position that is visible to the passersby passing outside the building. Otherwise, it may be possible also for the emergency event display means to be installed on the rooftop of the building, for instance.

Examples of the emergency events as stated in the present invention include emergency events related to damages to health in situations where there is some resident or some building tenant falling into an unmovable state due to one's own sudden illness or in a seriously injured state and other emergency events related to damages from crimes in situations where there is some intrusion by an illegal intruder such as a burglar or by a suspicious person into the residence or into a tenant office or store in the building, for instance.

In this case, while it is rare that there is a plurality of emergency events simultaneously, precautional measures thereagainst can be taken by dividing a display section into some parts or by providing a spare display section so as to allow an indication of such simultaneous emergency events to be displayed in a mutually distinguished manner, even in the simultaneous emergency event situations.

Alternatively, it may be possible also for the emergency event display means to make a way of displaying or a display position variable depending on whether the emergency event taking place is fire and/or accident or resident's sudden illness and/or injury or intrusion by the illegal intruder such as a burglar or by the suspicious person.

Meanwhile, a telephone or like other reporting means can be also provided in the manner of being connectively attached to the emergency event display means. Installation of a direct reporting means having a direct line to a police station, an emergency services facility and a security company etc. enables the emergency event to be immediately reported thereto in accordance with an indication displayed on the emergency event display means.

Further, the emergency event display means can be jointly provided with a communication function for other individual display means installed in each individual residence and/or the common use space, thereby making it possible to take an emergency contact with a speech means or a display means in each individual residence nearby an emergency event occurrence spot or in each individual residence and/or the common use space on a specific floor. However, it is desirable that some limitation should be imposed on use of the communication function in accordance with an emergency event occurrence time and/or a type of emergency event, as needed, so as to prevent the communication function from being uselessly used.

Meanwhile, for the purpose of preventing an illegal intruder from attempting to intrude into the building by intentionally giving a false notification and/or operation from the outside of the building, it can be considered that limitation should be imposed on a signal path, or alternatively, some programmable security should be applied.

As to the emergency event notification means installed in each individual residence or the common use space in the building, use can be made of such a wireless or wired notification device as being equipped with an operation button or a speech means, for instance, in which case, however, it is to be noted that the form of the notification device is not particularly limited. Alternatively, a communication device as a pendant-, bracelet- or key-shaped extension unit can be also used in combination with a land-line type notification device as a main unit.

In regards to the emergency event display means, it may be possible also to provide a shared emergency event display means capable of being used commonly in a plurality of proximate buildings without being limited to the emergency event display means installed in one building, wherein the shared emergency event display means may be configured so as to receive an emergency event notification sent by an emergency event notification means installed in each building, followed by displaying information concerning an emergency event in the proximate buildings, together with information concerning a residence or common use space location in the proximate buildings where the emergency event notification is sent.

The shared emergency event display means may be installed in a position that is visible from a road or a passage nearby any one of the proximate buildings or nearby at least two buildings. In this case, it may be possible also for the shared emergency event display means to be installed within the building site of any one of the proximate buildings or in a plot of land separately secured outside the building site.

One important requirement under which emergency event detection by the residents and/or by the passerby should be realized in an easier way and in an earlier stage is that the emergency event display means itself should be made attractive or noticeable enough to attract people's interests and attentions.

As to one approach to make the emergency event display means itself noticeable enough to attract people's interests and attentions as described the above, it is desirable that the emergency event display means should be configured as a device also serving as an ornamental picture, photo or video display means or a promotional image or video display means so as to normally catch people's eyes.

Specifically, a display device equipped with a large screen display can be used as the emergency event display means, for instance, to normally show an ornamental picture, photo or video or alternatively, a promotional image or video, while switching the whole or part of a screen to allow an indication that there is the emergency event in the building to be displayed, upon receipt of the emergency event notification.

It is to be noted that the emergency event display means is not limited to such a display device as being independently installed by itself, like the display device equipped with the large screen display, and accordingly, in terms of a display device of such a type as giving display on the exterior wall surface of the building, for instance, use can be also made of a display device equipped with a projector device that projects projection videos toward a screen, with the exterior wall surface of the building as the screen.

Further, for the purpose of allowing the emergency event display means to catch more people's eyes enough to normally attract people's interests and attentions, it can be considered that a mascot as a symbol for the building or a molded article made in imitation in the form of an animal and/or plant, a vehicle or an artwork should be provided to install the emergency event display means in close proximity to such mascot or molded article.

Alternatively, it may be possible also for the emergency event display means to be integrally installed into such mascot as the symbol for the building or into such molded article.

Meanwhile, the emergency event display means can be a display means equipped with a voice output means, in addition to a character, image or video output means. Accordingly, when the emergency event notification is given not only by visual indication but also by voice, it becomes possible to arouse more people's attentions, and besides, the people at a remote place are also allowed to detect the emergency event.

Otherwise, in regards to the emergency event display means, it is to be noted that if one's budget permits, an emergency event display device of a simplified structure can be installed also in the building common use space such as the entrance in the building and an elevator hall on each floor.

While the emergency event display means can be installed also in a building management office or in an external remote monitoring facility, like the case of a typical notification system, it is to be noted that the emergency event display means thus installed as described the above can be an emergency event display means different in form from the device as the emergency event display means installed close to the entrance and/or other side entrance of the building.

Further, an emergency event display means equipped with a simple notification function may be installed also in each individual residence in the building to additionally implement a system that allows the residents in the building to mutually receive the emergency event notification.

### Effects of the Invention

Because of the fact that the notification system for buildings according to the present invention is mainly constituted of the notification means installed in each individual residence or the common use space in the building and the display means installed in the position that is visible to the passersby passing outside the building, and of the fact that the notification means itself can be a notification means of a simplified structure, it is easy for this notification system as a relatively low-cost system to be introduced and widely used in the ordinary collective housing and office complexes without the need to make a large investment in equipment.

Installation of the emergency event display means in a noticeable position such as a position that is visible from the road or passage nearby the building enables the emergency event to be detected not only by the residents in the building but also by the passersby passing nearby the building, thereby resulting in allowing early countermeasures against the emergency event to be taken thanks to early emergency event detection by the residents and the passersby, even when the building manager is absent. Accordingly, the emergency event taking place in the building can be notified in an effective way, thereby resulting in providing safety for the residents in the building.

When the emergency event display means itself is made noticeable in such a manner as to normally show the ornamental picture, image or video or alternatively, the promotional image or video on the emergency event display means, it is possible for the emergency event display means to normally catch people's eyes enough to attract people's interests and attentions, thereby resulting in allowing an unexpected emergency event notification to be transmitted more securely.

Namely, one approach to make the emergency event display means noticeable enough to allow also the passersby passing outside the building to pay attention to the emergency event display means on one's routine basis is considered to be effective in enabling the emergency event to be immediately detected not only by the residents but also by the passersby at a critical moment in which there is the emergency event.

Moreover, installation of the emergency event display means in combination with the mascot as the symbol for the building or with the molded article so as to normally catch the people's eyes enough to attract the people's interests and attentions makes it possible to provide higher safety for the building, while bolstering an impression of the building.

### BRIEF DESCRIPTION OF THE DRAWINGS

FIG. 1 is a perspective view conceptionally showing a situation in which an emergency event display means for use in a notification system for buildings according to the present invention is installed.

FIG. 2 is a perspective view conceptionally showing a situation in which an emergency event notification means for use in the notification system for buildings according to the present invention is installed in a residence of a building.

FIG. 3 is a cross-sectional view of a building to conceptionally show the relation between the emergency event notification means installed in each individual residence and the emergency event display means installed within a building site in regard to the notification system for buildings according to the present invention.

FIG. 4 is a plan view showing one embodiment related to an installation position of the emergency event display means for use in the notification system for buildings according to the present invention.

FIG. 5 is a plan view showing another embodiment related to the installation position of the emergency event display means for use in the notification system for buildings according to the present invention.

FIG. 6 is a plan view showing still another embodiment related to the installation position of the emergency event display means for use in the notification system for buildings according to the present invention.

### MODE FOR EMBODYING THE INVENTION

Hereinafter will be described the present invention with reference to the attached drawings.

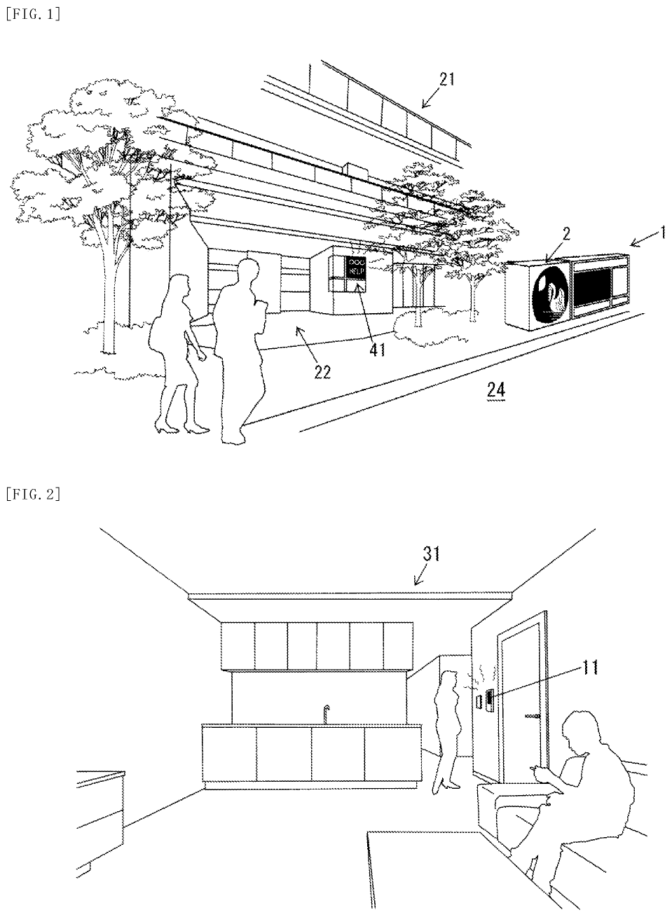

FIG. 1 conceptionally shows one embodiment related to a situation in which an emergency event display means for use in a notification system for buildings according to the present invention is installed.

Referring to this embodiment shown, an emergency event display device 1 equipped with a large screen display is installed as an emergency event display means within a building site facing a road passing in front of a building 21 as collective housing.

While the emergency event display device 1 installed in a position close to an entrance of the building 21 is shown in FIG. 1 from a drawing point of view, it is to be noted that the present invention assumes that the emergency event display device 1 shall be installed within a site of the building 21 so as to be located in a position facing a road 24 as shown in FIG. 4, for instance, without being limited to the position close to the building entrance.

Installation of the emergency event display device 1 within the site of the building 21 so as to be located in a noticeable position facing the road 24 enables an emergency event to be easily detected not only by residents in the building 21 and/or home delivery staffs but also by passersby passing nearby the building 21, when there is some emergency event in the building.

The screen display of the emergency event display device 1 normally shows an ornamental picture, photo or video so as to soothe the residents walking in and out of the building 21 or the passersby passing in front of the building, and accordingly, an impression of the building can be bolstered. Alternatively, it may be possible also for this screen display to show a promotional image or video, instead of the ornamental picture and/or video.

In this case, a storage medium with image data stored therein can be utilized to change a picture and/or photo image, unlike a framed picture or photo. Alternatively, a data receiving means based on a communication line can be also utilized to change the image or video as needed, or to give the video in real time.

When there is, in the building, some emergency event such as resident's sudden illness or injury and illegal intrusion by an intruder or by a suspicious person, an indication of the emergency event is displayed on the emergency event display device 1, upon receipt of an emergency event notification from each individual residence or a common use space where an emergency event notification means is installed. The emergency event notification means and the emergency event display device 1 are directly or indirectly connected to an in-building network based on a wired or wireless communication line, and consequently, information from the emergency event notification means can be displayed on the emergency event display device 1 through a controller etc. Meanwhile, it is to be noted that an external monitoring facility or like facility may be also interposed therebetween for management.

In terms of the form of display related to an indication of an emergency event, the whole or part of the screen of the screen display of the emergency event display device 1 can be switched to allow an indication that there is the emergency event in the building to be displayed, upon receipt of the emergency event notification, for instance. In this case, information concerning the emergency event notified by the emergency event notification means is displayed together with information such as information concerning a residence or common use space location where the emergency event notification is sent, for instance.

When the emergency event display device is provided with a speaker or like voice output means, in addition to display of an indication of the emergency event by character or image and video information on the screen display of the emergency event display device 1, the emergency event notification can be given not only by visual indication but also by voice, and consequently, it becomes possible to arouse more people's attentions. Besides, the emergency event can be notified also to the people at a remote place.

As shown in FIG. 1, it may be possible also for the emergency event display device 1 to attract more people's attentions in such a way as to install an object 2 indicative of a mascot as a symbol for the building or a molded article made in imitation in the form of an animal and/or plant, a vehicle and an artwork etc., for instance, so as to be located close to the emergency event display device 1, or alternatively, to integrally install the emergency event display device 1 into such mascot or molded article, thereby resulting in providing higher safety for the building, while bolstering an impression of the building.

It is to be noted that installation of the emergency event display means in a plurality of places without being limited to one place is considered to be more effective, or alternatively, a separate emergency event display means may be installed also close to the entrance or other side entrance of the building. Referring to one embodiment shown in FIG. 1, a separate emergency event display means 41 is installed also on the exterior wall surface by the side of the building entrance.

Otherwise, although not shown, an emergency event display means of a simplified structure can be installed also in the common use space in the building, such as the entrance of the building and an elevator hall on each floor. Further, an emergency event display means equipped with a simple notification means may be installed also in each individual residence in the building to additionally implement a system that allows the residents in the building to mutually receive the emergency event notification.

Moreover, a separate emergency event display means can be installed also in a building management office or in an external remote monitoring facility, like the case of a typical notification system.

FIG. 2 conceptionally shows one embodiment related to a situation in which the emergency event notification means for use in the notification system for buildings according to the present invention is installed in the residence of the building.

Referring to this embodiment shown, a notification-cum-display device 11 equipped with a simple display function in addition to an emergency event notification function is installed in each individual residence 31 of the building such as collective housing so as to enable the emergency event to be notified by the notification-cum-display device 11, in cases where there is some resident in need of rescue due to one's own sudden illness or injury or where there is some illegal intrusion by an intruder into the residence 31.

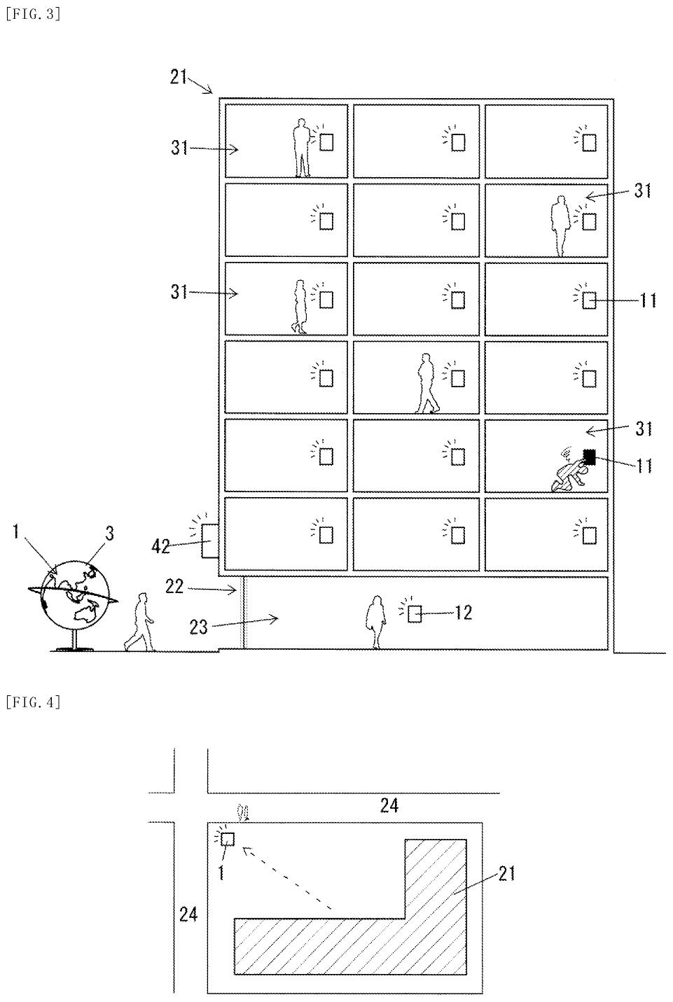

FIG. 3 conceptionally shows the relation between the emergency event notification means installed in each individual residence and the emergency event display means installed outside the building in regard to one embodiment of the notification system for buildings according to the present invention.

Referring to this embodiment shown, the notification-cum-display device 11 is installed in each individual residence 31 of the building 21 as the collective housing, and besides, a common use space notification-cum-display device 12 is installed also in an entrance hall 23 on the first floor.

The emergency event display device 1 equipped with the large screen display is installed within the site of the building 21 so as to be located in a position facing roads around the building 21, and an ornamental picture, photo or video, or alternatively, a promotional image or video is normally displayed on the screen display of the emergency event display device 1.

According to this embodiment, it is to be noted that the emergency event display device 1 is incorporated into a globe-shaped molded article 3, and the ornamental picture, photo or video, or alternatively, the promotional image or video is normally displayed on the screen display of the emergency event display device 1.

Further, according to this embodiment, an emergency event display device 42 is mounted also on an exterior wall surface of a second-floor part above an entrance 22, in addition to the emergency event display device 1 installed within the site of the building 21.

When the notification indicative of resident's sudden illness or injury is received from any one of the residences 31 of the building 21 as the collective housing or when the notification indicative of intrusion by a suspicious person is received from the entrance hall 23, the whole or part of the screen of the screen display of the emergency event display device 1 is switched to allow an indication that there is the emergency event in the building to be displayed.

In this case, information concerning the emergency event notified by the emergency event notification means is displayed, together with information concerning a residence or common use space location where the emergency event notification is sent, for instance.

FIG. 4 shows one embodiment related to an installation position of the emergency event display means for use in the notification system for buildings according to the present invention, in the case where the emergency event display device 1 is installed for one building 21, more specifically, within the site of one building so as to be located in a position facing roads around the building site. It may be possible also for the emergency event display device 1 to be installed in a plurality of positions within the building site.

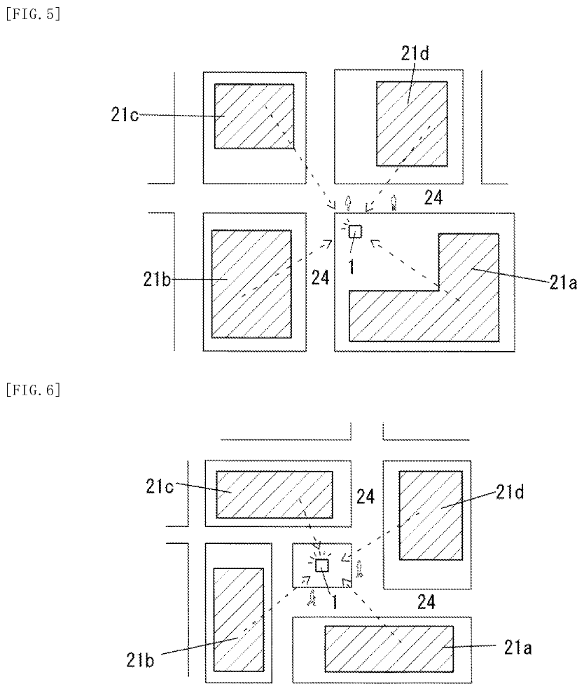

FIGS. 5 and 6 respectively show other embodiments related to the installation position of the emergency event display means for use in the notification system for buildings according to the present invention. The emergency event display means can be a shared emergency event display device 1 capable of being used commonly in a plurality of proximate buildings 21a, 21b, 21c, 21d, without being limited to the emergency event display means installed for one building 21 as shown in FIG. 4.

Namely, the shared emergency event display device 1 can be configured so as to receive the emergency event notification sent by the emergency event notification means installed in each building 21a, 21b, 21c, 21d, followed by displaying information concerning the emergency event in the proximate buildings, together with information concerning a residence or common use space location in the proximate buildings 21a, 21b, 21c, 21d where the emergency event notification is sent.

In this case, the shared emergency event display device 1 may be installed in a position that is visible from the road 24 or the passage nearby any one of the proximate buildings 21a, 21b, 21c, 21d or nearby at least two buildings.

Specifically, the shared emergency event display device 1 may be installed within the site of any one of the proximate buildings 21a, 21b, 21c, 21d (that is, the building 21a in FIG. 5) as shown in FIG. 5, or alternatively, in a plot of land separately secured outside the building site, as shown in FIG. 6.

### EXPLANATION OF REFERENCE NUMERALS

1 . . . Emergency event display device, 2 . . . Object indicative of mascot, 3 . . . Molded article, 11 . . . Notification-cum-display device, 12 . . . Common use space notification-cum-display device, 21 . . . Building, 22 . . . Entrance, 23 . . . Entrance hall, 24 . . . Road, 31 . . . Residence, 41, 42 . . . Emergency event display device

1. A notification system for buildings, characterized in that an emergency event notification means is installed in each individual residence or a common use space in a building, said emergency event notification means being connected to an in-building network based on a communication means to send an emergency event notification, and an emergency event display means is installed on an exterior wall surface of said building so as to be located in a position that is visible to passersby passing outside said building, said emergency event display means being for receiving the emergency event notification sent by said emergency event notification means, followed by displaying information concerning an emergency event notified by said emergency event notification means, together with information concerning a residence or common use space location where said emergency event notification is sent.

2. The notification system for buildings according to claim 1, wherein said emergency event display means is installed on an external wall surface close to an entrance of said building.

3. A notification system for buildings, characterized in that an emergency event notification means is installed in each individual residence or a common use space in a building, said emergency event notification means being connected to an in-building network based on a communication means to send an emergency event notification, and an emergency event display means is installed outside the building within a site of said building so as to be located in a position that is visible to passersby passing outside said building, said emergency event display means being for receiving the emergency event notification sent by said emergency event notification means, followed by displaying information concerning an emergency event notified by said emergency event notification means, together with information concerning a residence or common use space location where said emergency event notification is sent.

4. A notification system for buildings, characterized in that an emergency event notification means is installed in each individual residence or a common use space in a plurality of proximate buildings, said emergency event notification means being connected to an in-building network based on a communication means to send an emergency event notification, and an emergency event display means is installed in a position that is visible to passersby passing outside said proximate buildings, said emergency event display means being for receiving the emergency event notification sent by said emergency event notification means, followed by displaying information concerning an emergency event notified by said emergency event notification means, together with information concerning a residence or common use space location where said emergency event notification is sent, wherein said emergency event display means is configured so as to receive the emergency event notification sent by said emergency event notification means installed in said proximate buildings, followed by displaying information concerning the emergency event in said proximate buildings, together with information concerning the residence or common use space location in said proximate buildings where said emergency event notification is sent.

5. The notification system for buildings according to claim 4, wherein said emergency event display means is installed in a position that is visible from a road or a passage nearby any one of said proximate buildings or nearby at least two buildings.

6. The notification system for buildings according to claim 4, wherein said emergency event display means is installed within a site of any one of said proximate buildings or in a plot of land separately secured outside the building site.

7. The notification system for buildings according to claim 1, wherein said emergency event display means also serves as an ornamental picture, photo or video display means or a display means that shows a promotional image or video.

8. The notification system for buildings according to claim 1, wherein a building mascot or a molded article is installed in close proximity to said emergency event display means.

9. The notification system for buildings according to claim 1, wherein said emergency event display means is integrally installed into a building mascot or into a molded article.

10. The notification system for buildings according to claim 1, wherein said emergency event display means is equipped with a voice output means, in addition to a character, image or video output means.

11. The notification system for buildings according to claim 1, wherein said emergency event display means is installed in the common use space and a management office in the building or in an external remote monitoring facility as well.

12. The notification system for buildings according to claim 1, wherein said emergency event display means is installed also in each individual residence in said building.

13. The notification system for buildings according to claim 1, wherein said emergency event notification means includes a wireless or wired notification device equipped with an operation button or with a speech means.
